(19) United States
(12) Patent Application Publication
(10) Pub. No.: US 2019/0195468 A1
(43) Pub. Date: Jun. 27, 2019

(54) REFLECTION FILM

(71) Applicant: Chunghwa Picture Tubes, LTD., Taoyuan City (TW)

(72) Inventors: Wen-Jiunn Hsieh, New Taipei City (TW); Yu-Chen Chou, Taoyuan City (TW)

(73) Assignee: Chunghwa Picture Tubes, LTD., Taoyuan City (TW)

(21) Appl. No.: 15/915,069

(22) Filed: Mar. 8, 2018

(30) Foreign Application Priority Data
Dec. 26, 2017 (CN) 201711428377.7

(51) Int. Cl. F21V 13/08; F21V 9/30

(52) U.S. Cl. CPC F21V 13/08; B82Y 20/00; F21V 9/30

(57) ABSTRACT

A reflection film including a reflection film substrate and a wavelength conversion layer is provided. The wavelength conversion layer is disposed on the reflection film substrate. The wavelength conversion layer includes a wavelength conversion material, a plurality of nanoparticles and a base material. Since the reflection film of the invention includes the wavelength conversion material and the plurality of nanoparticles, the backlight brightness and the color saturation of the display using the reflection film of the invention are improved.

### CROSS-REFERENCE TO RELATED APPLICATION

This application claims the priority benefit of China application serial no. 201711428377.7, filed on Dec. 26, 2017. The entirety of the above-mentioned patent application is hereby incorporated by reference herein and made a part of this specification.

### BACKGROUND OF THE INVENTION

### Field of the Invention

The invention relates to a reflection film, and particularly relates to a reflection film including a wavelength conversion material.

### Description of Related Art

In today's technology, by coating a reflection film behind a backlight source of a display, a light-emitting efficiency of the light source may be improved, to enhance a light-emitting brightness of the display. Therefore, the reflection film is an important component in the display, and reflectivity thereof may influence a brightness effect of the display.

In the existing technology, a method for forming the reflection film is to add scattering inorganic particles to a polymer film or forming hollow pores in the polymer film. The reflection film has a light reflecting effect due to a difference between refractive indexes of the polymer film and the inorganic particles and the hollow pores. However, the reflection film obtained based on the above method has a problem of yellow-stain due to absorption of an ultraviolet light and heat emitted by a light-emitting diode (LED) bar, which results in a fact that reflectivity of the reflection film is decreased. Presently, a commonly used solution is to add an ultraviolet absorbent in the polymer film, however, although the ultraviolet absorbent has a protection effect, it also has many disadvantages, and the biggest disadvantage is that a spectral absorption band thereof generally extends to a blue light part of a visible light, so that the film presents a yellow tone. Therefore, in order to avoid the color changing problem of the film, only a small amount of the ultraviolet absorbent may be added, however, the small amount of the ultraviolet absorbent cannot achieve a complete protection effect, and after the film is irradiated by the light source for a period of time, the problem of yellow-stain is still occurred.

Therefore, to produce a reflection film capable of mitigating the problem of film yellow-stain, improving a backlight brightness and improving a color saturation is a target to be achieved in this field at present.

### SUMMARY OF THE INVENTION

The invention is directed to a reflection film, which does not have a problem of yellow-stain and is adapted to provide higher backlight brightness and color saturation.

Other objects and advantages of the invention can be further illustrated by the technical features broadly embodied and described as follows.

The invention provides a reflection film including a reflection film substrate and a wavelength conversion layer. The wavelength conversion layer is disposed on the reflection film substrate. The wavelength conversion layer includes a wavelength conversion material, a plurality of nanoparticles and a base material.

In an embodiment of the invention, the wavelength conversion material comprises a quantum dot material, a rod-like material, or a combination thereof.

In an embodiment of the invention, a particle diameter of the quantum dot material is 0.5 nm-200 nm.

In an embodiment of the invention, a length of the rod-like material is 5 nm-500 nm, and a diameter of the rod-like material is 5 nm-200 nm.

In an embodiment of the invention, the wavelength conversion material includes a III-V group semiconductor material, a II-VI group semiconductor material, a IV-VI group semiconductor material, or a combination thereof.

In an embodiment of the invention, the wavelength conversion material is doped with a dopant, and the dopant comprises manganese, boron, nitrogen, a rare earth element or a combination thereof.

In an embodiment of the invention, a particle diameter of the nanoparticles is 0.5 nm-100 nm.

In an embodiment of the invention, a material of the nanoparticles includes a metal material or a semiconductor material.

In an embodiment of the invention, the base material includes a thermosetting resin or a light cured resin.

In an embodiment of the invention, the reflection film substrate includes a pore structure.

Since the reflection film of the invention includes the wavelength conversion material, the wavelength conversion material may absorb the ultraviolet light capable causing the problem of yellow-stain and convert the same into a visible light, so that the backlight brightness and the color saturation of the reflection film are improved. Moreover, the reflection film of the invention further includes a plurality of nanoparticles, by which the visible light converted by the adjacent wavelength conversion material further improves the backlight brightness and the color saturation of the reflection film.

### BRIEF DESCRIPTION OF THE DRAWINGS

FIG. 1 is a cross-sectional view of a reflection film according to an embodiment of the invention.

FIG. 2 is a spectral energy distribution diagram of the reflection film of the invention only includes a wavelength conversion material and the reflection film includes both of the wavelength conversion material and a plurality of nanoparticles.

### DESCRIPTION OF EMBODIMENTS

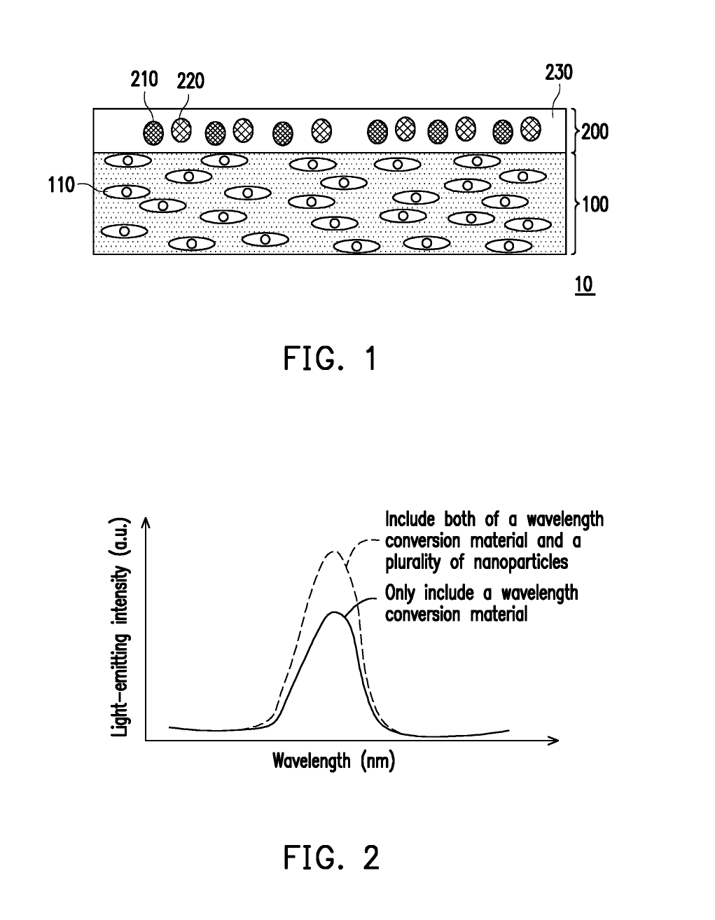

Referring to FIG. 1, the reflection film 10 of the invention includes a reflection film substrate 100 and a wavelength conversion layer 200. The reflection film 10 may be applied for a backlight or lighting of a liquid crystal display, though the invention is not limited thereto.

The reflection film substrate 100 includes a pore structure 110. In an embodiment, the pore structure 110 is composed of inorganic particles and/or bubbles. A material of the inorganic particles includes TiO₂, BaSO₄ or a combination thereof. A particle diameter of the inorganic particles is preferably 0.01 μm-2 μm. The content of the inorganic particles relative a total weight of the reflection film substrate 100 is 5-50%, and is preferably 10-20%. A material of the reflection film substrate 100 includes polyethylene terephthalate (PET), polypropylene (PP) or a combination thereof. In the present embodiment, the material of the reflection film substrate 100 is PET. It should be noted that the material of the reflection film substrate 100 is not particularly specified as long as it is properly selected according to a usage purpose or a required characteristic.

The wavelength conversion layer 200 is disposed on the reflection film substrate 100. A process of disposing the wavelength conversion layer 200 on the reflection film substrate 100 may be a film coating method, though the invention is not limited thereto. The wavelength conversion layer 200 includes a wavelength conversion material 210, a plurality of nanoparticles 220 and a base material 230.

In an embodiment, the wavelength conversion material 210 comprises a quantum dot material, a rod-like material, or a combination thereof. A particle diameter of the quantum dot material is preferably 0.5 nm-200 nm. A length of the rod-like material is preferably 5 nm-500 nm, and a diameter of the rod-like material is preferably 5 nm-200 nm. A material of the wavelength conversion material 210 includes a III-V group semiconductor material, a II-VI group semiconductor material, a IV-VI group semiconductor material, or a combination thereof. For example, the material of the wavelength conversion material 210 may be InP, InAs, CdSe, InGaAs, InAsP, InSb, ZnO, InS, InGaN, Si, GaN, graphene nanosheets(GNS), ZnS or a combination thereof. When the wavelength conversion material 210 is made of the above materials, the wavelength conversion material 210 may convert an ultraviolet light absorbed by thereof into a visible light, to avoid a problem of yellow-stain and improve a backlight brightness and a color saturation of the reflection film 10.

The wavelength conversion material 210 may be a single layer structure, a double layer structure or a multi-layer structure. In an embodiment, the wavelength conversion material 210 is a core-shell type double layer structure. When the wavelength conversion material 210 is the core-shell type double layer structure, a range of wavelengths changed by the wavelength conversion material 210 is enlarged (i.e. the ultraviolet light is more easy to be converted into the visible light), so that a wavelength conversion rate is enhanced. Moreover, when the wavelength conversion material 210 is the core-shell type double layer structure, it may protect a core structure to avoid oxidation. The wavelength conversion material 210 is doped with a dopant, and the dopant comprises manganese, boron, nitrogen, a rare earth element or a combination thereof. When the wavelength conversion material 210 is doped with the aforementioned elements, not only the wavelength conversion material 210 may maintain spectral characteristics of the undoped wavelength conversion material 210, but it may avoid reduction of a light-emitting intensity caused by a self-quenching problem due to Stokes shift.

A particle diameter of the nanoparticles 220 is preferably 0.5 nm-100 nm. A material of the nanoparticles 220 includes a metal material or a semiconductor material. For example, the material of the nanoparticles 220 may be a metal material of gold, silver, platinum, copper, aluminium or alloys thereof, etc., or a semiconductor material, and the above materials have characteristics of negative real part dielectric constant and small imaginary part dielectric constant. In an embodiment, the material of the nanoparticles 220 is gold nanoparticles.

Referring to FIG. 2, according to FIG. 2, it is known that a stronger light-emitting intensity is achieved when the reflection film 10 includes both of the wavelength conversion material 210 and the nanoparticles 220, and a reason thereof is that after the nanoparticles 220 are excited by the ultraviolet light, free electrons on the nanoparticles 220 have periodic relative displacement relative to ions on lattice. The charges are accumulated on an opposite surface due to the above relative displacement to cause increase of a local electric field intensity, which is referred to as a localized surface plasmon resonance (LSPR) effect. Through the LSPR effect of the nanoparticles 220 excited by the ultraviolet, the light-emitting intensity of the wavelength conversion material 210 may be further increased, to further improve the backlight brightness and the color saturation of the reflection film 10. Moreover, since the nanoparticles 220 have the effect of enhancing the light-emitting intensity, the desired light-emitting intensity may be obtained by adjusting an adding ratio of the wavelength conversion material 210 and the nanoparticles 220 according to an actual requirement. For example, a plurality of nanoparticles 220 may be added to decrease a usage amount of the wavelength conversion material 210, to decrease the process cost of the reflection film 10.

A material of the base material 230 may be a thermosetting resin or a light cured resin. For example, the material of the base material 230 is acrylic resin, epoxy resin or a combination thereof. In the wavelength conversion layer 200, the amount of the wavelength conversion material 210 is preferably 0.1 wt %-10 wt %, the amount of the nanoparticles 220 is preferably 0.05 wt %-10 wt %, and the amount of the base material 230 is preferably 80 wt %-99.85 wt %.

Since the reflection film of the invention includes the wavelength conversion material, the wavelength conversion material may absorb the ultraviolet light capable causing the problem of yellow-stain and convert the same into a visible light, so that the backlight brightness and the color saturation of the reflection film are improved. Moreover, by using the wavelength conversion material with the core-shell type double layer structure, a range of wavelengths changed by the wavelength conversion material is enlarged, to increase a wavelength conversion rate. Moreover, the reflection film of the invention further includes a plurality of nanoparticles, and based on the LSPR effect of the nanoparticles excited by the ultraviolet light, the visible light converted by the adjacent wavelength conversion material further improves the backlight brightness and the color saturation of the reflection film.

1. A reflection film, comprising:
a reflection film substrate; and
a wavelength conversion layer, disposed on the reflection film substrate, wherein the wavelength conversion layer comprises a wavelength conversion material, a plurality of nanoparticles and a base material, through a LSPR effect of the nanoparticles excited by an ultraviolet, a light-emitting intensity of the wavelength conversion material is further increased.

2. The reflection film as claimed in claim 1, wherein the wavelength conversion material comprises a quantum dot material, a cylinder-like material, or a combination thereof.

3. The reflection film as claimed in claim 2, wherein the wavelength conversion material comprises the quantum dot material, a particle diameter of the quantum dot material is 0.5 nm-200 nm.

4. The reflection film as claimed in claim 2, wherein the wavelength conversion material comprises the cylinder-like material, a length of the cylinder-like material is 5 nm-500 nm, and a diameter of the cylinder-like material is 5 nm-200 nm.

5. The reflection film as claimed in claim 1, wherein the wavelength conversion material comprises a III-V group semiconductor material, a II-VI group semiconductor material, a IV-VI group semiconductor material, or a combination thereof.

6. The reflection film as claimed in claim 1, wherein the wavelength conversion material is doped with a dopant, and the dopant comprises manganese, boron, nitrogen, a rare earth element or a combination thereof.

7. The reflection film as claimed in claim 1, wherein a particle diameter of the plurality of nanoparticles is 0.5 nm-100 nm.

8. The reflection film as claimed in claim 1, wherein the plurality of light-emitting enhancement nanoparticles comprise a metal material or a semiconductor material.

9. The reflection film as claimed in claim 1, wherein the base material comprises a thermosetting resin or a light cured resin.

10. The reflection film as claimed in claim 1, wherein the reflection film substrate comprises a pore structure.
